(19) United States
(12) Patent Application Publication
(10) Pub. No.: US 2006/0285799 A1
(43) Pub. Date: Dec. 21, 2006

(54) Integrated circuit device with optically coupled layers

(76) Inventors: Sean M. Spillane, Mountain View, CA (US); Wei Wu, Mountain View, CA (US); Shih-Yuan Wang, Palo Alto, CA (US); Raymond G. Beausoleil, Redmond, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/158,660

(22) Filed: Jun. 21, 2005

(51) Int. Cl. G02B 6/26

(52) U.S. Cl. 385/50; 385/14

(57) ABSTRACT

Optical coupling between a first waveguide in a first layer of an integrated circuit device and a second waveguide in a second layer of the integrated circuit device vertically separated from the first layer is described. An optical signal is propagated through a spheroidal element optically coupled to each of the first and second waveguides and positioned between the first and second layers.

### FIELD

This patent specification relates to coupling signals between different layers of an integrated circuit device.

### BACKGROUND

Integrated circuit devices have become essential components in a wide variety of products ranging from computers and robotic devices to household appliances and automobile control systems. New applications continue to be found as integrated circuit devices become increasingly capable and fast while continuing to shrink in physical size and power consumption. As used herein, integrated circuit device refers broadly to a device having one or more integrated circuit chips performing at least one electrical and/or optical function, and includes both single-chip and multi-chip devices. In multi-chip devices, each integrated circuit chip is usually separately fabricated or “built up” from a substrate, and the resultant chips are bonded together or otherwise coupled into a common physical arrangement.

Advances in integrated circuit technology continue toward reducing the size of electrical circuits to smaller and smaller sizes, such that an entire local electrical circuit (e.g., a group of memory cells, a shift register, an adder, etc.) can be reduced to the order of hundreds of nanometers in linear dimension, and eventually even to tens of nanometers or less. At these physical scales and in view of ever-increasing clock rates, limitations arise in the data rates achievable between different parts of the integrated circuit device, with local electrical circuits having difficulty communicating with “distant” electrical circuits over electrical interconnection lines that may be only a few hundred or a few thousand microns long.

To address these issues, proposals have been made for optically interconnecting different electrical circuits in an integrated circuit device. For example, in the commonly assigned U.S. 2005/0078902A1, a photonic interconnect system is described that avoids high capacitance electric interconnects by using optical signals to communicate data between devices.

As part of such optical interconnection schemes, optical coupling between planar waveguides located on different integrated circuit layers is often needed. In a simplest proposal applicable to inter-chip coupling, two chips are mounted side-by-side such that an edge facet of a first waveguide on the first chip directly abuts an edge facet of a second waveguide on the second chip. In another proposal, an optical fiber is used to transfer optical signals between the two edge facets of the different chips. In yet another proposal, an optical fiber is used to couple between a surface-emitting source on the first chip and a detector on the second chip, each chip having electrical-to-optical (E-O) and optical-to-electrical (O-E) converter(s) as necessary. However, issues arise for such proposals that limit their operational scalability (e.g., the number of optical interconnections achievable between chips) and/or the amount of achievable device compactness.

Vertical optical coupling schemes have also been proposed in which an optical signal is transferred between planar waveguides located on facing layers of vertically arranged chips, the vertical arrangement providing for a smaller footprint while also accommodating a larger number of optical interconnections between the facing chips. Proposals include the use of angled reflecting structures and/or grating structures for urging vertical projection out of one planar waveguide and corresponding vertical collection into the other planar waveguide.

Issues arise, however, in relation to optical coupling efficiency, especially as the vertical spacing between the planar waveguides is increased. Increases in vertical spacing between the two waveguiding layers may be desirable in many circumstances, such as for accommodating different chip assembly methods, enhancing heat dissipation, reducing crosstalk between facing electrical elements, accommodating vertical surface features on the facing surfaces, or for a variety of other reasons. Other issues include one or more of device complexity, alignment issues, fabrication cost, and mechanical stability during or after device fabrication. Still other issues arise as would be apparent to one skilled in the art upon reading the present disclosure. It would be desired to provide for optical coupling between different layers of an integrated circuit device, whether such layers be all-optical or electro-optical, in a manner that addresses one or more of these issues.

### SUMMARY

In one embodiment, a method for coupling an optical signal from a first waveguide in a first layer of an integrated circuit device to a second waveguide in a second layer of the integrated circuit device is provided, the second layer being vertically separated from the first layer. The optical signal is propagated through a spheroidal element optically coupled to each of the first and second waveguides and positioned between the first and second layers.

Also provided is an integrated circuit device comprising a first layer including a first waveguide and a second layer including a second waveguide, the first and second layers being vertically separated. A spheroidal element is optically coupled to each of the first and second waveguides and positioned between the first and second layers. The spheroidal element facilitates coupling of an optical signal between the first waveguide and the second waveguide.

Also provided is an apparatus comprising a vertical arrangement of integrated circuit layers including a first layer and a second layer. A first waveguide is formed in the first layer and a second waveguide is formed in the second layer. Spheroidal coupling means in optical communication with each of the first and second waveguides is provided for coupling an optical signal therebetween.

### BRIEF DESCRIPTION OF THE DRAWINGS

FIG. 1 illustrates a perspective view of an integrated circuit device according to an embodiment;

FIG. 2 illustrates a side cut-away view of an integrated circuit device according to an embodiment;

FIGS. 3A-3C illustrate optical spectra associated with the integrated circuit device of FIG. 2;

FIG. 4 illustrates a perspective view of a lower layer and a plurality of spheroidal elements of an integrated circuit device according to an embodiment;

FIG. 5 illustrates a side cut-away view of an integrated circuit device according to an embodiment;

FIG. 6 illustrates a side cut-away view of an integrated circuit device according to an embodiment; and

FIG. 7 illustrates a side cut-away view of an integrated circuit device according to an embodiment.

### DETAILED DESCRIPTION

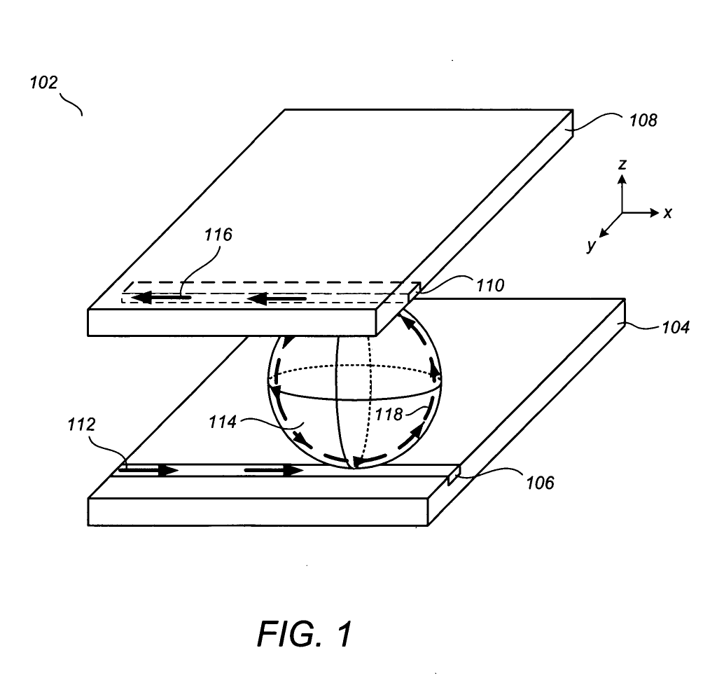

FIG. 1 illustrates a perspective view of an integrated circuit device 102 according to an embodiment, comprising a lower layer 104 containing a first waveguide 106 and an upper layer 108 containing a second waveguide 110. The layers 104 and 108 may be from two different integrated circuit chips that have been glued together, bonded together, or otherwise assembled into a vertical arrangement. Alternatively, the layers 104 and 108 may in a common integrated circuit chip. As used herein, a layer of an integrated circuit device refers to a vertically contiguous slab-like subvolume of the integrated circuit device. It is to be appreciated that a layer may itself comprise a plurality of material sub-layers having relatively complex structures and functionalities. Thus, for example, the layers 104 and 108 may each comprise several adjacent sub-layers of differing materials formed, processed, patterned, or otherwise fabricated to achieve various electrical, electrooptical, and/or optical functionalities.

The layers 104 and 108 may both be all-optical or may both be electrooptical. Alternatively, one of the layers 104 and 108 may be all-optical and the other may be electro-optical. In one embodiment, the lower layer 104 may comprise densely-packed arrays of electrical circuits, each being laterally adjacent to a nearby optical communications port having O-E and E-O conversion elements, while the upper layer 108 may comprise an “optical LAN” facilitating information transfer of information among “distant” electrical circuits on the layer 104. In another embodiment, the layers 104 and 108 may be used for facilitating the photonic interconnect system described in the commonly assigned U.S. 2005/0078902A1, supra.

According to an embodiment, integrated circuit device 102 further comprises a spheroidal element 114 positioned between the lower layer 104 and the upper layer 108, the spheroidal element 114 being optically coupled to each of the first waveguide 106 and the second waveguide 110 such that an input optical signal 112 propagating along the first waveguide 106 is coupled into an output optical signal 116 in the second waveguide 110. In one embodiment, the spheroidal element 114 is configured and dimensioned to sustain a whispering gallery mode (WGM) resonance at a frequency of the optical signal 112, with WGM resonance modes being indicated by arrows along a propagation loop 118 in FIG. 1. When configured to achieve a WGM resonance condition at one or more frequencies, the spheroidal element 114 propagates light analogously to devices variously referenced in the literature as spherical microresonators, whispering gallery mode microresonators, spherical cavities, whispering gallery mode cavities, spherical dielectric cavities, and resonant spherical cavities.

The spheroidal element 114 comprises a material having a higher index of refraction than that of the surrounding material, which can be air or a low-index material. Light propagates in a curved path along an outer periphery of the spheroidal element 114 by total internal reflection, the spheroidal element 114 having a diameter that is generally large relative to the wavelength of the light. Generally speaking, a WGM resonance condition can arise where the circumferential path length corresponds to an integer number of wavelengths of the light. In an embodiment where the spheroidal element 114 is a solid microsphere with diameter D surrounded by air and having a refractive index of nₛ, the WGM resonance condition can be characterized by Eq. (1) below:

$$\frac{M λ}{{n}_{s} f} = D \qquad \{ 1 \}$$

In the above equation, λ is the free space wavelength of the light, M is an integer substantially greater than 1 (M>>1) and in practice often substantially greater than 100 (M>>100), and f is a parameter-dependent factor that is less than 1 but that approaches 1 as M grows substantially larger than 100. Generally speaking, the parameter f will be dependent on other parameters such as particular geometries and polarizations used, as well as the particular resonance mode excited. Microspheres fabricated using known methods, such as silica microspheres shaped by surface tension forces, have been demonstrated to sustain WGM resonances with very high quality factors Q (a measure relating to a ratio of stored modal energy versus cavity losses), for example, 10000 and greater. In general, the light is laterally confined to within a few wavelengths on either side of an x-z plane passing through a center of the spheroidal element 114. The WGM resonance condition of Eq. (1) is achieved at a periodic succession of peak wavelengths, each corresponding to a successive value of the integer M, the peak wavelengths being approximately separated by a distance Δλ set forth in Eq. (2):

$$Δ λ \approx \frac{{λ}^{2}}{{n}_{s} S} \qquad \{ 2 \}$$

It is to be appreciated that the use of a microsphere for the spheroidal element 114, which is presented for clarity of description above, is but one of many different types of spheroidal elements that can be used in accordance with the present teachings. More generally, the spheroidal element 114 can have a variety of different shapes, material compositions, structural compositions, and sizes without departing from the scope of the present teachings. As used herein, the term spheroidal volume broadly includes any solid volume providing an at least roughly circular or ellipsoidal propagation loop within a plane passing therethrough, while also having at least some degree of laterally arcuate shape along a periphery of the propagation loop to maintain the light near that plane. Thus, for example, the spheroidal element 114 of FIG. 1 confines the optical signal to the propagation loop 118 within a central x-z plane passing therethrough, and also provides a laterally arcuate shape in the y-direction along a periphery of the propagation loop to maintain light near that central x-z plane. A wide variety of different shapes can be used as the spheroidal element 114 including, but not limited to: ellipsoidal shapes having relatively low aspect ratios, ellipsoidal shapes having relatively high aspect ratios; and shapes that approximate such ellipsoidal shapes near a central plane passing therethrough but that otherwise deviate from such shape away from that central plane (e.g., football, egg, or cigar-shaped elements, truncated ellipsoids that are “chopped off” at outlying ends, etc.). However, for clarity of description, and not by way of limitation, the spheroidal element 114 is characterized hereinbelow as having a single size dimension D corresponding to a diameter of a spherical element. One skilled in the art would be readily able to derive, either mathematically or empirically, appropriate corresponding dimensions for non-spherical cases and/or non-circular peripheral propagation paths.

A wide variety of different material and structural compositions can be used for the spheroidal element 114, including solid structures, hollowed structures, and coated structures. For example, the spheroidal element can comprise a low-index core region surrounded by a coating of high-index material. Generally speaking, modal stability and device performance is enhanced where the spheroidal element 114 has a substantially higher refractive index (e.g., 2:1 or 3:1) than the surrounding material at its outer surface. Generally speaking, the size of the spheroidal element 114 can be made smaller as this refractive index ratio is increased. One particularly suitable material for the spheroidal element 114 is chalcogenide glass, which has a refractive index in the range of 2.4-2.8. Other suitable materials include other high-index glasses and sapphire. If a high-index outer coating is used, that coating should have a thickness of at least about λ/2n_{c} for sufficient propagation of an optical signal around the periphery of the spheroidal element 114, where n_{c} is the refractive index of the coating.

The waveguides 106 and 110 can be formed onto or into the layers 104 and 108 according to any of a variety of different waveguiding material systems. In one embodiment, silicon-on-insulator (SOI) substrates and an Si/SiO₂ material system is used. In another embodiment, an SiN/SiO₂ material system is used. Other suitable material systems include, but are not limited to, GaAs/AlGaAs, InGaAsP/InP, and other III-V material systems.

A wide variety of different sizes for the spheroidal element 114 and a wide variety of different wavelengths for the optical signal 112 are within the scope of the present teachings. By way of example and not by way of limitation, the optical signal 112 may be in the range of 400-1600 nm and the spheroidal element 114 may be between 20 μm and 2 mm in size.

In one embodiment, the spheroidal element 114 is dimensioned and configured relative to the waveguides 106 and 110 such that evanescent coupling is achieved for the propagating optical signal, wherein an evanescent field of the WGM modes overlaps with evanescent fields of the waveguides 106 and 110 in a phase-matched manner. Generally speaking, very high coupling efficiencies between the input optical signal 112 and the output optical signal 116, such as 90 percent or greater, can be achieved when such evanescent coupling is used. In other embodiments, one or both of the waveguides 106/110 can be coupled into the spheroidal element 114 using a non-evanescent coupling method, such as direct coupling by facet contact.

In some embodiments, the waveguides 106 and 110 are identical to each other in the vicinity of the spheroidal element 114, and the spheroidal element 114 is configured and positioned in a symmetric manner relative to each of them, such that a two-way vertical coupler is achieved. In other embodiments, these structures and/or couplings are made asymmetric in a manner that optimizes coupling in one direction, usually at the expense of coupling in the other direction.

Particular parameters for achieving coupling between the input optical signal 112 and the output optical signal 116 will be highly dependent on the particular wavelengths, refractive indices, loss coefficients, polarizations, coupling geometries, and physical dimensions used, as well as the particular resonance modes that are to be excited. By way of example only, and not by way of limitation, for a typical optical communications wavelength of 1.55 μm, Si/SiO₂ waveguides can be used with a chalcogenide glass spheroidal element 160 μm in diameter. In view of the present disclosure, one skilled in the art would be readily able to mathematically and/or empirically determine suitable combinations of such parameters providing sufficient optical coupling.

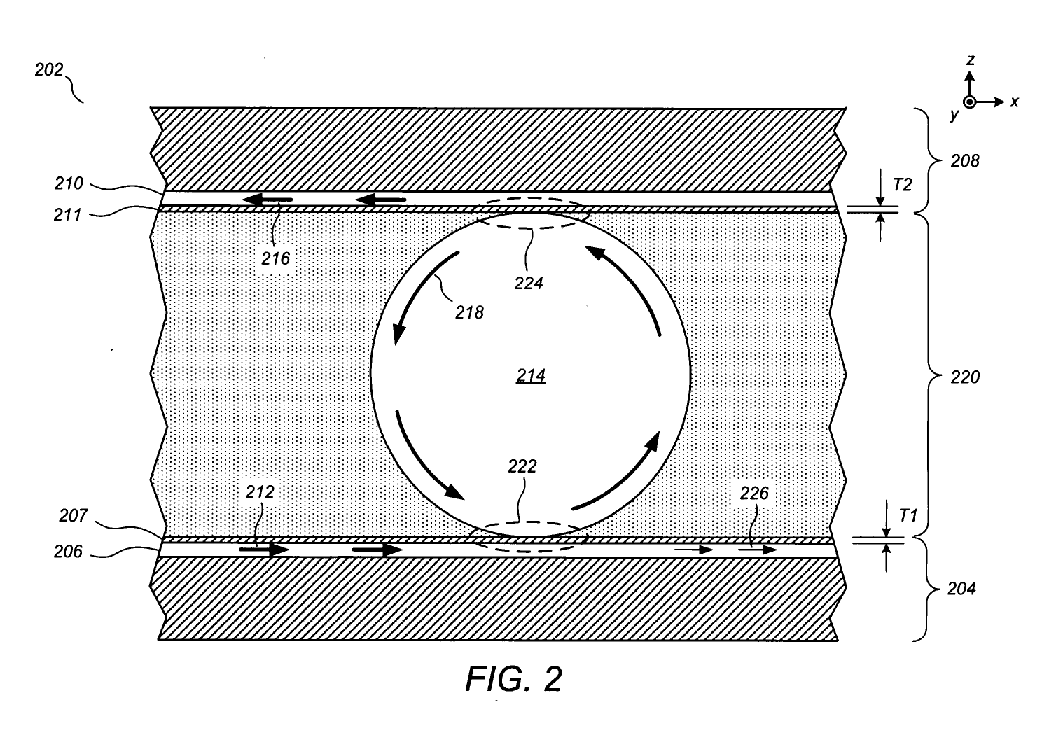

FIG. 2 illustrates a side cut-away view of an integrated circuit device 202 according to an embodiment, comprising a lower layer 204 containing a first waveguide 206, an upper layer 208 containing a second waveguide 210, and a spheroidal element 214 evanescently coupled to each of the waveguides 206 and 210 at evanescent coupling regions 222 and 224, respectively, such that an input optical signal 212 in the first waveguide 206 couples through the spheroidal element 214 into an output signal 216 in the second waveguide 210. In this example and hereinbelow, the waveguiding structures and their associated layers comprise Si/SiO₂ material systems by way of non-limiting example.

In the embodiment of FIG. 2, an intermediate layer 220 having a vertical dimension coextensive with that of the spheroidal element 214 is filled at locations therearound with a low-index material such polyamide, polymethyl-methacrylate (PMMA) or other various low-index liquids, gels, pastes, or solid materials. In other embodiments, the intermediate layer 220 can simply comprise air at those locations.

Also shown in FIG. 2 are spacing layers 207 and 211, which may comprise SiO₂, serving as both waveguide cladding and as spacers for optimizing the evanescent couplings by virtue of careful selection of their respective thicknesses T1 and T2. By way of nonlimiting example, the thicknesses T1 and T2 may be on the order of 100 nm. In other embodiments, the thicknesses T1 and/or T2 may be zero (i.e., the layers 207/211 are omitted).

Also shown in FIG. 2 is an optical signal 226 representing a portion of the optical signal 212 that does not couple into the spheroidal element 214. For purposes of clarity of description hereinbelow, it is assumed that cavity losses are negligible and that the “drop” coupling at region 222 from the first waveguide 206 into the spheroidal element 214 is identical to the “add” coupling at region 224 from the spheroidal element 214 into the second waveguide 210. Accordingly, for any particular wavelength λ, if there is a ratio of signal powers P₂₂₆/P₂₁₂(λ) near zero, then there is a very high vertical coupling efficiency between the lower and upper waveguides 206 and 210 for that wavelength, while a very low vertical coupling efficiency for that wavelength is indicated if the ratio P₂₂₆/P₂₁₂(λ) is near 1.0.

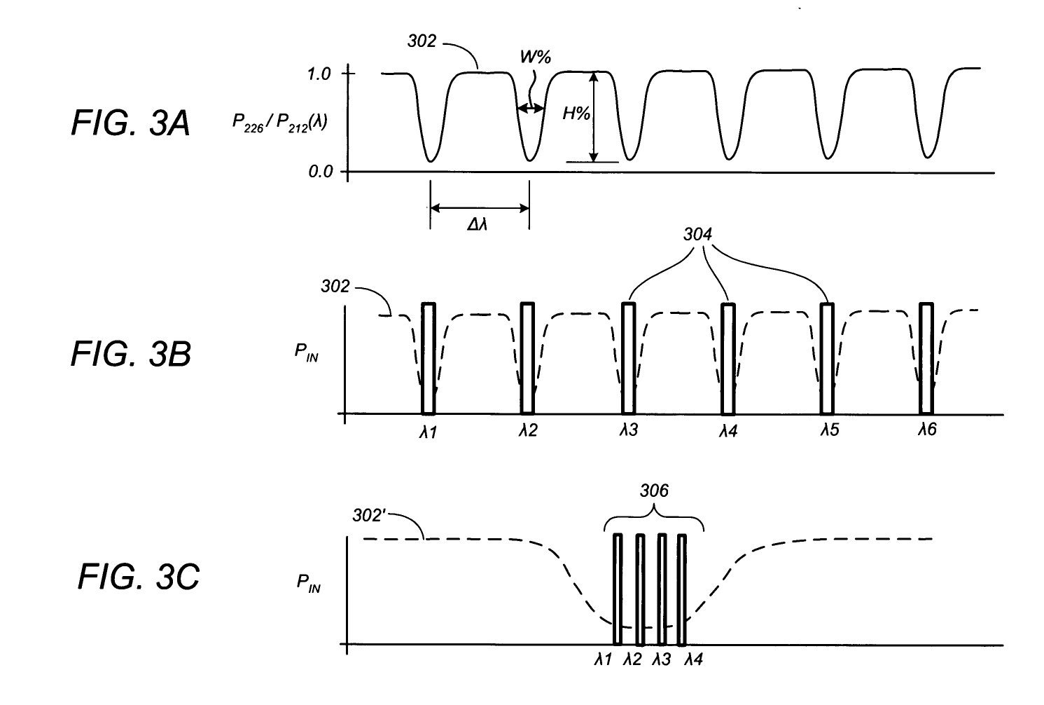

FIGS. 3A-3C illustrates optical spectra associated with the integrated circuit device 202 of FIG. 2. FIG. 3A illustrates a curve 302 of P₂₂₆/P₂₁₂(λ), with dips corresponding to WGM resonant modes separated by a uniform spacing Δλ according to Eq. (2), supra, the dips being associated with wavelengths of high vertical coupling efficiency. In one embodiment, the optical signal 212 is a wavelength-division multiplexed (WDM) signal having adjacent center wavelengths at λ1, λ2, λ3, etc. In one embodiment (see FIG. 3B, spectra 302 and 304), successive center wavelengths of the WDM signal are designed to correspond to successive WGM resonance modes of the spheroidal element 214. In another embodiment (see FIG. 3C, spectra 302′ and 306), successive center wavelengths of the WDM signal are designed to correspond to a single WGM resonance mode of the spheroidal element 214. More generally, the spheroidal element 214 will sustain high WGM resonance (and therefore high vertical coupling efficiency) for a first subset of component wavelength ranges of the optical signal 212, and will have diminished WGM resonance (and therefore low vertical coupling efficiency) for a second subset of component wavelength ranges. Various optical filtering schemes and multiplexing/demultiplexing schemes can therefore be used in conjunction with the vertical coupling provided by the spheroidal element 214.

The shape of the curve 302 for P₂₂₆/P₂₁₂(A) is characterized in part by a WGM resonance bandwidth W, expressed as a percentage of the WGM mode separation Δλ, and by a peak height percentage H. The values for W, H, and Δλ can be highly influenced by variation of different material parameters, geometries, and materials used in the vertical coupling scheme of FIG. 2. By way of example, reducing the Q of the spheroidal element 214 by using lossier materials serves to increase the bandwidth W (although decreasing the peak height percentage H). By way of example and not by way of limitation, for the 160 μm chalcogenide spheroidal element mentioned previously, a Q of 10000 or less is required to accommodate 10 Gbps modulation of any particular WDM channel near 1.55 μm. Increasing the refractive index ns or diameter of the spheroidal element reduces the WGM mode separation Δλ. Increasing the thickness T1 of the spacer layer 207 generally reduces W but can positively or negatively influence H depending on the present thickness T1 and other details.

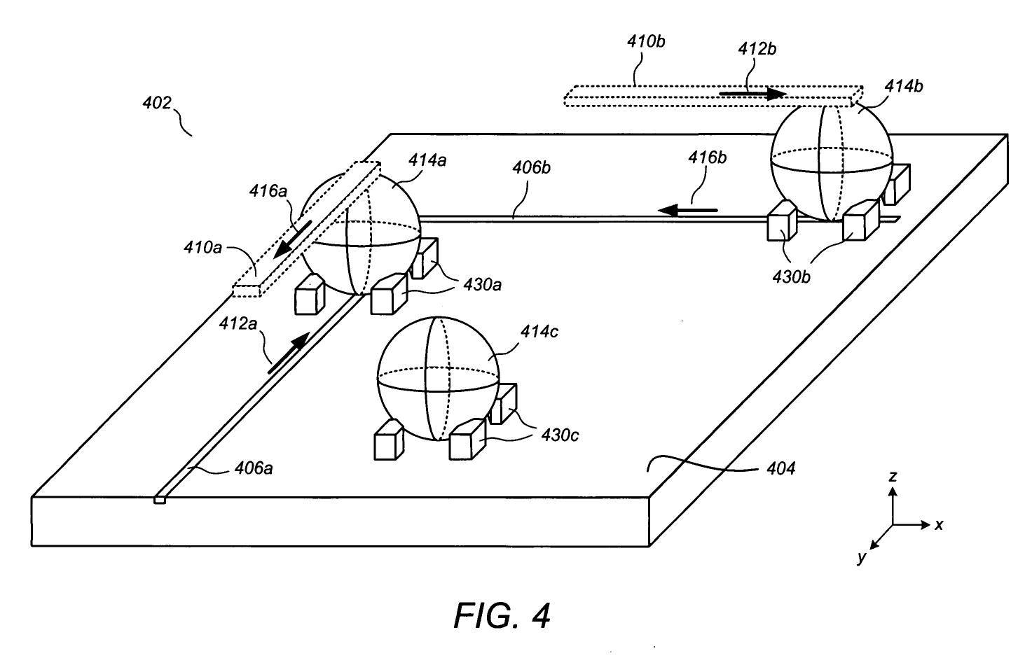

FIG. 4 illustrates a perspective view of a lower layer 404 of an integrated circuit device 402 according to an embodiment. An upper layer of the integrated circuit device 402 is omitted from FIG. 4 for clarity of presentation, with only waveguides 410a-410b therein being shown as dotted lines. According to an embodiment, the integrated circuit device 402 comprises at least three spheroidal elements 414a-414c of generally similar dimension positioned in a non-collinear manner between the lower layer 404 and the upper layer. Mechanical stability is facilitated, either during the fabrication process, such as during the curing of a paste into a solid material, or on a long term basis, such as when only air is present.

As indicated in FIG. 4, spheroidal element 414a provides for vertical coupling of an input optical signal 412a in a first waveguide 406a of the lower layer 404 into an output optical signal 416a in a second waveguide 410a of the upper layer, while spheroidal element 414b provides for vertical coupling of an input optical signal 412b in a third waveguide 410b of the upper layer into an output optical signal 416b in a fourth waveguide 406b of the lower layer 404. In contrast, spheroidal element 414c is “dark” and provided only for mechanical stability.

Also shown in FIG. 4 are alignment structure groups 430a-430c corresponding respectively to the spheroidal elements 414a-414c, for facilitating their alignment and placement during the fabrication of the integrated circuit device and for further facilitating mechanical stability afterward. Difficulties in alignment and placement of the spheroidal elements 414a-414c, which are usually separately pre-fabricated, are thereby at least partially alleviated. The alignment structure groups 430a-430c form part of the lower layer 404 and may comprise the same material as, or a different material than, the surrounding surface of the lower layer 404. Each of the alignment structure groups 430a-430c comprises at least three alignment structures or “bumps” for contacting the corresponding spheroidal element at locations not intersecting a propagation path of the optical signal, so as not to interfere with the vertical coupling.

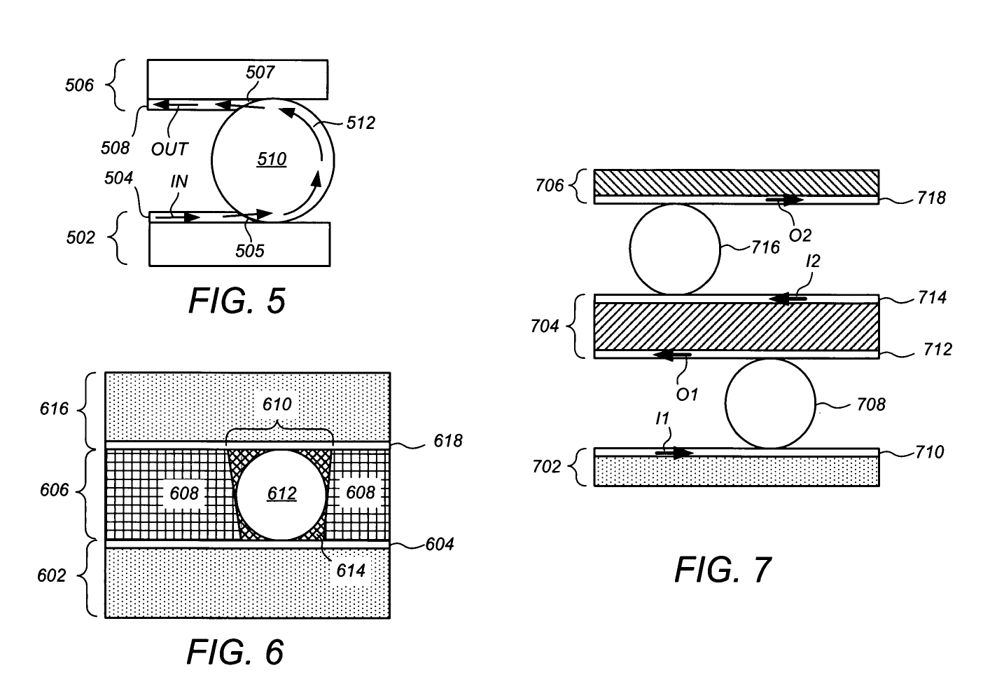

FIG. 5 illustrates a side cut-away view of an integrated circuit device according to an embodiment comprising a lower layer 502 containing a first waveguide 504, an upper layer 506 containing a second waveguide 508, and a spheroidal element 510 providing for vertical coupling of an input optical signal “IN” in the first waveguide 504 into an output signal “OUT” in the second waveguide 508. According to the embodiment of FIG. 5, the spheroidal element 510 is directly coupled with the waveguides 504 and 508 by contact with respective facets 505 and 507 thereof. The optical signal propagates in a non-resonant manner directly between the facets 505 and 507, in a single trip along an outer arc of the spheroidal element 510 as shown by arrows 512.

FIG. 6 illustrates a side cut-away view of an integrated circuit device according to an embodiment particularly advantageous from a fabrication perspective when it is desired to built up the lower and upper layers from a common substrate. A lower layer 602 having a first waveguide 604 is formed, and an intermediate layer 606 is formed thereabove by depositing a uniform-thickness layer of a first low-index material 608. A trench 610 is created in the intermediate layer 606, a spheroidal element 612 is deposited in the trench. The trench 610 is then flowably backfilled with a second low-index material 614, which may be an uncured phase of the same compound as material 608 or which may be a different compound. An upper layer 616 having a second waveguide 618 is then formed thereabove. Thus, the first and second layers 602 and 616 are separated by the low-index intermediate layer 606, and the spheroidal element 612 is located within the trench 610 formed in the intermediate layer 606.

FIG. 7 illustrates a side cut-away view of an integrated circuit device according to an embodiment comprising a vertical assembly of layers including a first layer 702 containing a first waveguide 710 on an upper surface thereof and a second layer 704 containing a second waveguide 712 on a lower surface thereof. A first spheroidal element 708 provides for vertical coupling of an input optical signal I1 in the first waveguide 710 into an output signal O1 in the second waveguide 712. The second layer 704 further contains a third waveguide 714 on an upper surface thereof. The vertical assembly further comprises a third layer 706 containing a fourth waveguide 718 on a lower surface thereof. A second spheroidal element 716 provides for vertical coupling of an input optical signal I2 in the third waveguide 714 into an output signal O₂ in the fourth waveguide 718.

Fabrication of integrated circuit devices according to one or more of the embodiments can be achieved using known integrated circuit fabrication methods including, but not limited to: deposition methods such as chemical vapor deposition (CVD), metal-organic CVD (MOCVD), plasma enhanced CVD (PECVD), chemical solution deposition (CSD), sol-gel based CSD, metal-organic decomposition (MOD), Langmuir-Blodgett (LB) techniques, thermal evaporation/molecular beam epitaxy (MBE), sputtering (DC, magnetron, RF), and pulsed laser deposition (PLD); lithographic methods such as optical lithography, extreme ultraviolet (EUV) lithography, x-ray lithography, electron beam lithography, focused ion beam (FIB) lithography, and nanoimprint lithography; removal methods such as wet etching (isotropic, anisotropic), dry etching, reactive ion etching (RIE), ion beam etching (IBE), reactive IBE (RIBE), chemical-assisted IBE (CAIBE), and chemical-mechanical polishing (CMP); modifying methods such as radiative treatment, thermal annealing, ion beam treatment, and mechanical modification; and assembly methods such as wafer bonding, surface mount, and other wiring and bonding methods.

Whereas many alterations and modifications of the embodiments will no doubt become apparent to a person of ordinary skill in the art after having read the foregoing description, it is to be understood that the particular embodiments shown and described by way of illustration are in no way intended to be considered limiting. By way of example, while in one or more the above embodiments the spheroidal element and the input/output waveguides are passive components, in other embodiments active components may be used that, responsive to one or more electrical and/or optical control signals, serve to modulate, amplify, filter, multiplex/demultiplex, or otherwise control a property of the optical signal.

By way of further example, although evanescent coupling and direct coupling by facet contact are described for coupling the planar waveguides with the spheroidal element, in other embodiments the optical signal may couple into the spheroidal element by angular projection from grating structures, reflecting structures, or various modulated optical sources. By way of still further example, although the present teachings are particularly advantageous in the context of ever-shrinking hybrid optoelectronic devices, they are readily applicable to all-optical integrated circuit devices (e.g., as used in all-optical computing devices), as well as to larger-sized devices.

By way of even further example, although one or more of the embodiments is particularly useful for obviating the need for optical fiber connections between chips, optical fibers may still be used for various other purposes in the integrated circuit device (e.g., importing higher-power optical carrier signals from off-chip lasers) without departing from the scope of the present teachings. By way of still further example, although one or more of the embodiments is particularly useful where the layers are each contained on integrated circuit chips, the scope of the present teachings includes scenarios where one layer is on an integrated circuit chip, and the other layer is on a printed-circuit board or other type of back-plane/packaging assembly. Thus, reference to the details of the described embodiments are not intended to limit their scope.

1. A method for coupling an optical signal from a first waveguide in a first layer of an integrated circuit device to a second waveguide in a second layer of the integrated circuit device vertically separated from the first layer, comprising propagating the optical signal through a first spheroidal element optically coupled to each of the first and second waveguides and positioned between said first and second layers, said integrated circuit device comprising a vertical assembly of a plurality of integrated circuit chips, said first layer being an upper layer of a first of said integrated circuit chips and said second layer being a lower layer of a second of said integrated circuit chips, said spheroidal element facilitating optical communications between said first and second integrated circuit chips, said integrated circuit device further comprising at least two additional spheroidal elements of similar dimensions as said first spheroidal element, said additional spheroidal elements being positioned between said first and second layers and laterally distributed relative to said first spheroidal element such that mechanical stability of said vertical assembly is facilitated.

2. The method of claim 1, wherein said first spheroidal element sustains a whispering gallery mode (WGM) resonance at a frequency of the optical signal.

3. The method of claim 2, wherein the first spheroidal element is evanescently coupled with each of said first and second waveguides at said frequency of said optical signal.

4. The method of claim 2, wherein said first spheroidal element is directly coupled with the first waveguide by contact with a facet thereof.

5. The method of claim 1, wherein said first spheroidal element is directly coupled with each of the first and second waveguides by contact with respective facets thereof, and wherein the optical signal propagates in a non-resonant manner directly between said facets along an outer arc of the first spheroidal element.

6. (canceled)

7. (canceled)

8. The method of claim 1, said first and second layers being separated by a gap, said gap having a thickness associated with a dimension of said first spheroidal element, wherein said gap is occupied by one of air and a low-index material at locations laterally surrounding said first spheroidal element.

9. The method of claim 1, said second integrated circuit chip having an upper layer including a third waveguide therein, said integrated circuit device further comprising a third integrated circuit chip having a lower layer including a fourth waveguide therein, said integrated circuit device further comprising a further additional spheroidal element positioned between said upper layer of said second integrated circuit chip and said lower layer of said third integrated circuit chip and optically coupled to each of said third and fourth waveguides for facilitating optical communications between said second and third integrated circuit chips.

10. The method of claim 1, wherein said first layer comprises at least three alignment structures contacting said first spheroidal element at locations not intersecting a propagation path of the optical signal therethrough, said alignment structures facilitating positional stability of the first spheroidal element on said first layer during formation of said vertical assembly.

11. The method of claim 1, wherein said first layer is a lower layer of an integrated circuit chip, and wherein said second layer is an upper layer of a printed-circuit board.

12. The method of claim 1, said optical signal being a wavelength division multiplexed (WDM) signal comprising a plurality of component frequency ranges, said first spheroidal element sustaining a whispering gallery mode (WGM) resonance for a subset of said component frequency ranges, whereby said first spheroidal element transfers the optical signal from said first waveguide into said second waveguide for said subset of component frequency ranges and does not transfer the optical signal from said first waveguide into said second waveguide for the other component frequency ranges.

13. The method of claim 1, said optical signal being a first optical signal, a one of said at least two additional spheroidal elements being optically coupled between a third waveguide in said second layer and a fourth waveguide in said first layer, further comprising coupling a second optical signal from said third waveguide in said second layer to said fourth waveguide in said first layer by propagating the second optical signal through said one of said at least two additional spheroidal elements.

14. (canceled)

15. (canceled)

16. The method of claim 1, wherein at least one of said first waveguide, said second waveguide, and said first spheroidal element comprises an active material controlled by at least one of an electrical control signal and an optical control signal, and wherein said coupling the optical signal includes at least one of modulating, amplifying, multiplexing, and demultiplexing the optical signal.

17. An integrated circuit device, comprising:
a first layer including a first waveguide;
a second layer including a second waveguide, the first and second layers being vertically separated; and
a first spheroidal element optically coupled to each of the first and second waveguides and positioned between said first and second layers, the first spheroidal element facilitating coupling of an optical signal between said first waveguide and said second waveguide, said integrated circuit device comprising a vertical assembly of a plurality of integrated circuit chips, said first layer being an upper layer of a first of said integrated circuit chips and said second layer being a lower layer of a second of said integrated circuit chips, said integrated circuit device further comprising at least two additional spheroidal elements of similar dimensions as said first spheroidal element, said additional spheroidal elements being positioned between said first and second layers and laterally distributed relative to said first spheroidal element such that mechanical stability of said vertical assembly is facilitated.

18. The integrated circuit device of claim 17, wherein the optical signal has a wavelength between about 400-1600 nm, and wherein said first spheroidal element has an average major diameter between about 20 μm-2 mm.

19. The integrated circuit device of claim 18, wherein said first spheroidal element comprises chalcogenide glass, and wherein said first and second waveguides each comprise one of an Si/SiO₂ waveguide structure and a III-V waveguide structure.

20. The integrated circuit device of claim 17, wherein said first spheroidal element comprises one of a spherical element, an ellipsoidal element, a laterally truncated spherical element, and a laterally truncated ellipsoidal element.

21. The integrated circuit device of claim 17, wherein the first spheroidal element is evanescently coupled with each of said first and second waveguides at a wavelength of the optical signal and is configured to have a whispering gallery mode (WGM) resonance at said wavelength.

22. The integrated circuit device of claim 17, wherein said first spheroidal element is directly coupled with the first waveguide by contact with a facet thereof.

23. The integrated circuit device of claim 17, wherein said first spheroidal element is directly coupled with each of the first and second waveguides by contact with respective facets thereof, and wherein the optical signal propagates in a non-resonant manner directly between said facets along an outer arc of the first spheroidal element.

24. The integrated circuit device of claim 17, said second integrated circuit chip having an upper layer including a third waveguide therein, said integrated circuit device further comprising:
a third integrated circuit chip having a lower layer including a fourth waveguide therein; and
a further additional spheroidal element positioned between said upper layer of said second integrated circuit chip and said lower layer of said third integrated circuit chip and optically coupled to each of said third and fourth waveguides for facilitating optical communications between said second and third integrated circuit chips.

25. (canceled)

26. The integrated circuit device of claim 17, said first layer further comprising at least three alignment structures contacting said first spheroidal element at locations not intersecting a propagation path of the optical signal therethrough, said alignment structures facilitating positional stability of the first spheroidal element on said first layer.

27. The integrated circuit device of claim 17, wherein said first layer is a lower layer of an integrated circuit chip, and wherein said second layer is an upper layer of a printed-circuit board.

28. The integrated circuit device of claim 17, said optical signal being a wavelength division multiplexed (WDM) signal comprising a plurality of component frequency ranges, said first spheroidal element sustaining a whispering gallery mode (WGM) resonance for a subset of said component frequency ranges, whereby said first spheroidal element transfers the optical signal from said first waveguide to said second waveguide for said subset of component frequency ranges and does not transfer the optical signal from said first waveguide to said second waveguide for the other component frequency ranges.

29. (canceled)

30. The integrated circuit device of claim 17, wherein at least one of said first waveguide, said second waveguide, and said first spheroidal element comprises an active material controlled by at least one of an electrical control signal and an optical control signal, and wherein said coupling of the optical signal includes at least one of modulating, amplifying, multiplexing, and demultiplexing the optical signal.

31. An apparatus, comprising:
a vertical arrangement of integrated circuit layers including a first layer and a second layer;
a first waveguide formed in said first layer and a second waveguide formed in said second layer; and
spheroidal coupling means in optical communication with each of said first and second waveguides for coupling an optical signal therebetween, wherein said spheroidal coupling means comprises a first spheroidal element lying between said first and second layers, and wherein said apparatus further comprises at least two additional spheroidal elements of similar dimensions as said first spheroidal element also positioned between said first and second layers and laterally distributed relative to said first spheroidal element such that mechanical stability of said vertical arrangement is facilitated.

32. The apparatus of claim 31, wherein said first spheroidal element comprises a spherical microresonator.

33. The apparatus of claim 31, wherein said first spheroidal element is selected from the group consisting of: a spherical microresonator, an ellipsoidal microresonator, a laterally truncated spherical microresonator, and a laterally truncated ellipsoidal microresonator.

34. The apparatus of claim 31, wherein said spheroidal coupling means is evanescently coupled with each of said first and second waveguides at a wavelength of the optical signal and is configured to have a whispering gallery mode (WGM) resonance at said wavelength.

35. The apparatus of claim 31, wherein said spheroidal coupling means is directly coupled with each of the first and second waveguides by contact with respective facets thereof, and wherein the optical signal propagates in a non-resonant manner directly between said facets along an outer arc of the spheroidal coupling means.

36. (canceled)

37. The apparatus of claim 31, said spheroidal coupling means being a first spheroidal coupling means and said optical signal being a first optical signal, said apparatus further comprising:
a third layer positioned above said second layer and containing a third waveguide; and
a second spheroidal coupling means optically coupling a second optical signal between said third waveguide and a fourth waveguide contained on said second layer, wherein said second spheroidal coupling means comprises a further additional spheroidal element lying between said second and third layers.

38. The apparatus of claim 31, wherein at least one of said first waveguide, said second waveguide, and said spheroidal coupling means comprises an active material controlled by at least one of an electrical control signal and an optical control signal, and wherein said coupling the optical signal includes at least one of modulating, amplifying, multiplexing, and demultiplexing the optical signal.
